(19) United States
(12) Patent Application Publication
(10) Pub. No.: US 2005/0224402 A1
(43) Pub. Date: Oct. 13, 2005

(54) Installation for separating components in a plurality of parallel channels

(75) Inventors: Martin Kerhuel, Paris (FR); Michel Manach, Meudon (FR)

Correspondence Address: BIRCH STEWART KOLASCH & BIRCH, PO BOX 747, FALLS CHURCH, VA, 22040-0747, US

(73) Assignee: Bionisis, Le Plessis Robinson (FR)

(21) Appl. No.: 11/069,237

(22) Filed: Mar. 2, 2005

(30) Foreign Application Priority Data
Mar. 3, 2004 (FR) 0402205

(51) Int. Cl. B01D 15/08

(52) U.S. Cl. 210/198.2; 210/96.1; 210/143; 422/70; 422/105

(57) ABSTRACT

An installation for separating components, in particular by high-pressure liquid chromatography along a plurality of channels in parallel, the outlets from the channels being connected via controlled selective connection means to the inlets of parallel temporary storage means whose outlets are connected via controlled selective connection means to ducts for depositing in collector means or in disposal means.

The invention relates to an installation for separating components in a plurality of parallel channels, in particular by high-pressure liquid chromatography, capillary electrophoresis, or any other technique for separating components in ducts.

Such a separation installation makes it possible in particular to purify a given component or to extract the components from a mixture.

### BACKGROUND OF THE INVENTION

The development of high-throughput means for synthesizing chemical molecules, the development of techniques for parallel synthesis, and the growth in studies on biodiversity and on medicinal plants has led to ever-increasing needs in terms of molecule purification.

Separation systems operating by high-pressure liquid chromatography in parallel channels satisfy this requirement. The separate components in the various channels are collected by means of suitable receptacles placed at the outlet of each channel, and by means of moving arms each carrying the outlet of a separation channel and moved to place the various components leaving via said outlet into different receptacles.

The components separated in the different channels do not necessarily all leave those channels at the same time, so collection needs to be controlled in a manner that is independent for each channel, as a function of time, of volume, or of signals coming from one or more detectors.

It is necessary to have a large amount of space at the outlet of the separation channels in order to accommodate the moving arms and the collection receptacles, and it is necessary to cause the separated components to pass into capillary tubes of considerable length corresponding to the greatest expected volume of a separated component for collection, and such length encourages components that have been separated in the separating channels mixing back together again in the capillary tubes. The selection, collection, and discarding of components separated in the various different channels thus very quickly become complex and difficult to implement, once the number of separation channels in parallel increases.

One possibility would be to collect the components simultaneously from all of the channels in parallel as a function of time or of volume, however that would lead to at least some of the components remixing.

In conventional manner, the passage of different components that have been separated in a channel is detected by means for measuring the absorption of light radiation, e.g. ultraviolet light. Such detection makes it possible at a given point on a separation channel to determine the beginning and the end of the passage of some particular component, and also to determine its concentration.

In order to obtain additional information about the components passing along the separation channels, proposals have been made to associate a detector with a liquid chromatography system having a plurality of parallel separation channels, where the detector is of the mass spectrometer, light diffusion, or other type that destroys the sample under analysis. In a known device, the detector is fed in parallel from the various separation channels, and the samples to be analyzed are processed in turn in the detector by means of a rotary turret-type cylinder having a plurality of chambers that is provided in the detector. The information delivered by the detector corresponds to the molecular masses of the components and it is used to characterize the collected components and to decide whether they should be retained or discarded. Nevertheless, that known device has the drawback of being complex and very expensive and it does not make it possible to avoid the above-mentioned drawbacks associated with the difficulty of collecting separated components leaving a plurality of parallel separation channels.

### OBJECTS AND SUMMARY OF THE INVENTION

A particular object of the present invention is to provide a solution to this problem that is simple, effective, and inexpensive.

The invention provides an installation for separating components, in particular by high-pressure liquid chromatography in a plurality of parallel channels, the installation making it possible, at will, to select from amongst the components separated in the various channels, those components that are to be conserved and those that are to be discarded, and to collect with precision the components that are to be conserved without any risk of said components remixing at the time they are collected.

To this end, the invention provides an installation of the above-specified type, comprising a plurality of parallel separation channels, means for detecting the passage of components along the separation channels, and collector means for collecting at least some of the components leaving the separation channels, the installation comprising, between the outlet from each separation channel and the collector means, at least two parallel temporary storage means, first controlled selective connection means for selectively connecting the outlet of said separation channel to the inlet of one or the other of the temporary storage means, second controlled selective connection means for connecting the outlets of the temporary storage means to the collector means or to disposal means, and control means generating control signals for controlling said selective connection means on the basis of signals output by the detector means.

The parallel temporary storage means that are connected to the outlet of each separation channel serve to transform the continuous flows leaving the separation channels into discontinuous selective distribution of the separated components either to collector means or to disposal means, thereby facilitating and greatly simplifying the collection of separated components.

The various components leaving the different separation channels, which are stored separately from one another in the parallel temporary storage means, can be extracted therefrom in an order that is different from the order in which they left the separation channels, with the extraction order being determined as a function of the instants at which the components cease to arrive in the temporary storage means.

The temporary storage means can be emptied much more quickly than they are filled, thus making it possible to have plenty of time for preparing to distribute the separated components to the corresponding collector means or to the disposal means.

According to another characteristic of the invention, the installation also comprises a moving arm carrying the outlets from the temporary storage means, control means for controlling displacement of said arm in translation over collector means formed, for example, by plates of micro-wells, series of tubes, strips of reaction wells, or the like, and third controlled selective connection means for connecting the inlets of the temporary storage means to feed means for supplying gas or liquid under pressure to transport the components contained in the temporary storage means to the collector means or to the disposal means.

This moving arm has as many outlets as there are separation channels in the installation, or in a variant as many outlets as there are temporary storage means, and these outlets are brought successively over the various different collector means in order to transfer thereto those contents of the temporary storage means that are for conservation.

In a preferred embodiment, for each separator channel, the temporary storage means comprise at least two ducts having inlets connected in parallel via the first controlled selective connection means to the outlet of the separator channel and having outlets connected via the second controlled selective connection means either to ducts carried by the above-mentioned moving arm and leading to the collector means, or else to the disposal means.

The above-mentioned selective connection means are electrically-controlled valves in the preferred embodiment of the invention. Some of these means can be constituted by spring-loaded check valves, when they are required to allow or prevent fluid to flow as a function of the pressure of the fluid.

According to another characteristic of the invention, the detector means comprise cells for detecting the passage of the components separated in each channel of the installation, these detector cells being, for example, of the type that measure the absorption of light radiation, the detector means also comprising apparatus for measuring a magnitude characteristic of the components passing along said channels, said magnitude being constituted, for example, by the molecular mass of the components, and means for feeding the measurement apparatus with a string of samples taken from the separation channels.

The measurement apparatus used in the invention is fed in series by the different components taken from the separation channels, and it is of conventional type, and much less expensive than the apparatus used in the known prior art device.

In the preferred embodiment of the invention, the installation includes control means for taking a predetermined or programmable quantity of components from each separation channel, means for depositing the taken quantities into a duct connecting the sample-taking means in series to the measurement apparatus, and transport means for transporting the taken quantities of components along said duct to the measurement apparatus.

Preferably, the transport means include a flow-driving pump connected to the end of the duct remote from the measurement apparatus.

The sample-taking means are advantageously constituted by electrically-controlled valves, with one sample-taking means being connected to each separation channel and having a moving portion formed with or connected to a chamber for receiving a small predetermined volume of component, and means for selectively moving said moving portion to insert the reception-chamber-int-o the separation channel or into the duct leading to the measurement apparatus.

These means for sampling the component in the various separation channels are controlled simultaneously.

The above-specified control means provided in the installation comprise a data processor system receiving as input the signals output from the above-mentioned measurement apparatus, representing a magnitude characteristic of the components passing through the separation channels, and the output signals from the means for detecting the passage of said components in the separation channels, and which generate control signals for controlling the first and second selected connection means connecting the outputs of the separation channels to the inputs of the temporary storage means and the outputs of the temporary storage means to the collector means or to the disposal means, and also third selective connection means for connecting the inputs of the temporary storage means to means for feeding gas or liquid under pressure for transporting the component contained in the temporary storage means towards the collector means or towards the disposal means.

### BRIEF DESCRIPTION OF THE DRAWINGS

The invention will be better understood and other characteristics, details, and advantages thereof will appear more clearly on reading the following description made by way of non-limiting example and with reference to the accompanying drawings, in which:

FIG. 1 is a diagram of an installation of the invention;

FIG. 2 is a diagram of means for feeding the mass spectrometer of the FIG. 1 installation;

FIG. 3 is a graph showing the output signal from a cell for measuring the absorption of light radiation that is mounted on a separation channel; and

FIGS. 4a and 4b are diagrams showing the operation of the moving arm for distributing components in the collector means, in the installation of FIG. 1.

### MORE DETAILED DESCRIPTION

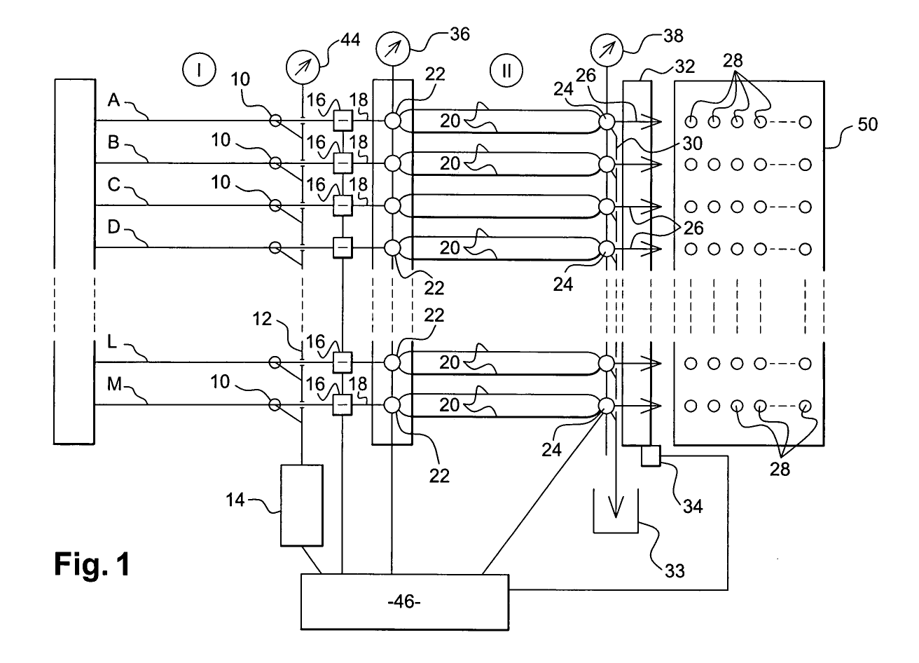

The installation of the invention which is shown diagrammatically in FIG. 1 comprises a first portion I which is an installation for separating the components of samples by high-pressure liquid chromatography, of the type commonly referred to by the initials HPLC or OPLC (over-pressure liquid chromatography), and a second portion II which is connected to the outlet from the first portion I for the purpose of temporarily storing the separated components leaving the separation channels of the first portion I, and for distributing them selectively to collector means or to disposal means or means for discharging waste to the sewer.

The first portion I comprises a plurality of separation channels A, B, C, D, . . . , L, M in parallel having their inputs fed with eluants, and each receiving a sample of a substance that is to have its various components separated, in particular for the purpose of characterizing their biological activities and their identities.

Each separation channel A, B, C, D, . . . is fitted, in the vicinity of its outlet, with means 10 for taking a small quantity of the components passing along the separation channel and for depositing the quantity of component that it takes into a duct 12 for feeding and apparatus 14 for measuring a magnitude that is characteristic of the components, this measurement apparatus 14 being of a type that destroys the molecules under analysis, e.g. a mass spectrometer or an evaporative detector using light diffusion.

Downstream from the means 10 for taking a small quantity of component, each separation channel A, B, C, D, . . . is fitted with a cell 16 for measuring the absorption of light radiation, such as ultraviolet radiation, by the components passing along the separation channel, the cell 16 being of a type that is well known to the person skilled in the art and serving to detect the beginning and the end of the passage of some particular component, and also its concentration.

Downstream from the detector cells 16, the outlets 18 from the separation channels are connected to the inlets of parallel temporary storage means 20 via controlled selective connection means 22 such as, for example, electrically-controlled valves and/or check valves. Each temporary storage means 20 is constituted by a capillary tube or the like of volume that is predetermined as a function of the largest volume of a component that is to be stored, the temporary storage means associated with the outlet of a separation channel having a number n of such capillary tubes, where n is greater than or equal to 2. The outlet from the temporary storage means 20 associated with a single separation channel are connected, by controlled selective connection means 24, such as electrically-controlled valves and/or check valves, either to a duct 26 for depositing a component in suitable collector means 28, or to a duct 30 for disposing or exhausting the component to a bin 33, a sewer, or the like.

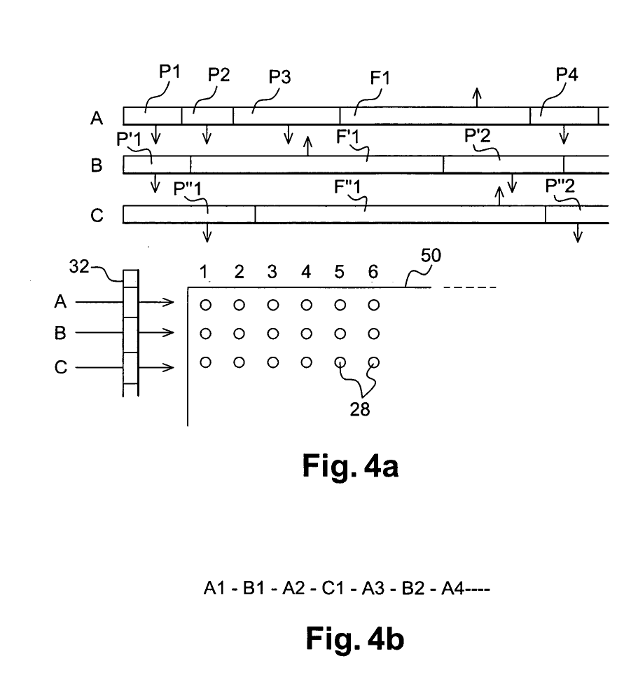

The various ducts 26 from which components are deposited into the collector means 28 are carried by a moving arm 32 which can be moved in translation by motor means 34 located above the collector means 28 so that the deposition duct 26 associated with a separation channel and then over a collector means 28 for depositing therein a first separated component coming from the separation channel, can be moved over another collector means 28 to deposit therein another separated component coming from the separation channel, and so on, as explained in greater detail below with reference to FIGS. 4a and 4b.

In a variant, the various ducts 26 for depositing components into the collector means 28, the disposal or exhaust duct 30, and the controlled selective connection means 24 at the outlet of the temporary storage means 20 can all be carried by the moving arm 32.

The depositing of components in the collector means 28 from the temporary storage means 20 is accelerated by admitting a suitable transport fluid into the inlet of the temporary storage means 20, e.g. compressed air or a liquid such as methanol or any solvent compatible with the eluant, and enabling cleaning to be performed, said fluid being supplied by a source 36 of fluid under pressure via the above-mentioned controlled selective connection means 22.

A source 38 of appropriate washing fluid, such as methanol or any solvent compatible with the eluant and enabling a duct to be washed, is connected to the outlets of the temporary storage means 20 via controlled selective connection means (not shown) for causing a washing fluid to pass along a deposition duct 26 when the output of a corresponding temporary storage means 20 is connected to the disposal duct 30.

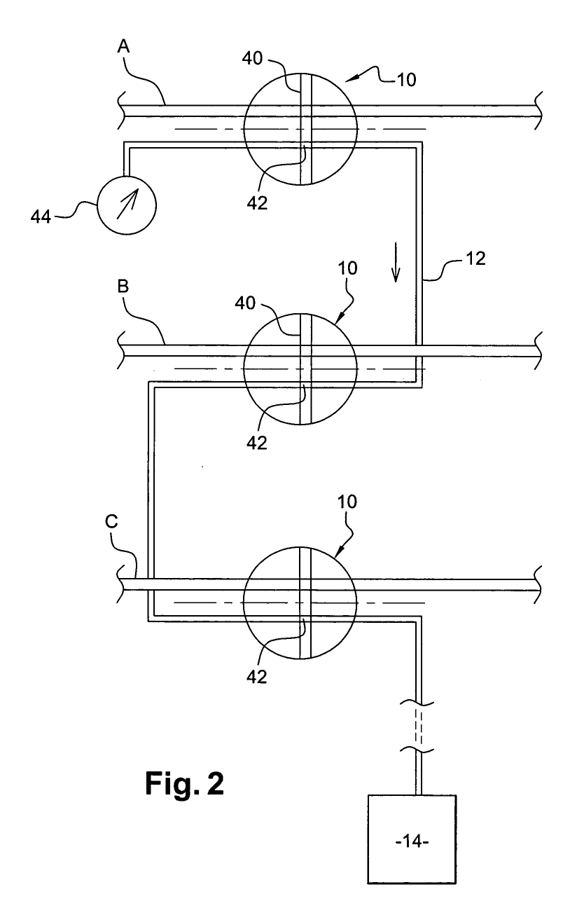

The means 10 for taking a small quantity of component from the separation channels A, B, C, . . . are shown in greater detail in FIG. 2, each comprising a electrically-controlled valve connected to the corresponding separation channel A, B, C, D, . . . and to the feed duct 12 for the measurement apparatus 14, the electrically-controlled valve having a moving portion 40 with a small chamber 42 having a predetermined small volume, typically one to a few microliters (μL), that can be inserted under the control of the valve either in the corresponding separation channel A, B, C, D, . . . , or else in the duct 12 for feeding the measurement apparatus 14.

In a variant, in order to take larger volumes from the separation channels, the moving portion 42 may be connected to a capillary tube having the desired capacity, instead of to the chamber 42.

At its end opposite from the measurement apparatus 14, the duct 12 is connected to a source 44 of a suitable transport liquid such as methanol, the source 44 comprising, for example, a pump enabling the duct 12 to be filled with transport liquid and enabling the liquid to be caused to flow to the measurement apparatus 14.

The sample-taking means 10 are operated simultaneously so as to deposit simultaneously in the duct 12 that is filled with transport liquid, corresponding quantities of the components contained in the chambers 42 that have been taken from the various separation channels. All of the valves are advantageously controlled by a single motor via a wormscrew or the like connected to the moving portions 40 of the valves. The moving portion 40 of each valve 10 is operated to insert the corresponding chamber 42 in the corresponding separation channel in order to fill it with the component that is passing at that moment along the separation channel, and then to return the chamber 42 so as to deposit the quantity of component that it has taken into the duct 12.

The various different quantities of component that are deposited simultaneously in the duct 12 form a train of samples in which each sample has a volume of one to a few microliters and is separated from the other samples by a larger volume, e.g. about 20 μL of the transport liquid. A train of four samples can thus have a total volume of about 100 μL. If the analysis capacity of the measurement apparatus 14 is about 1 milliliter (mL) per minute, this train of samples can be analyzed in about 6 seconds.

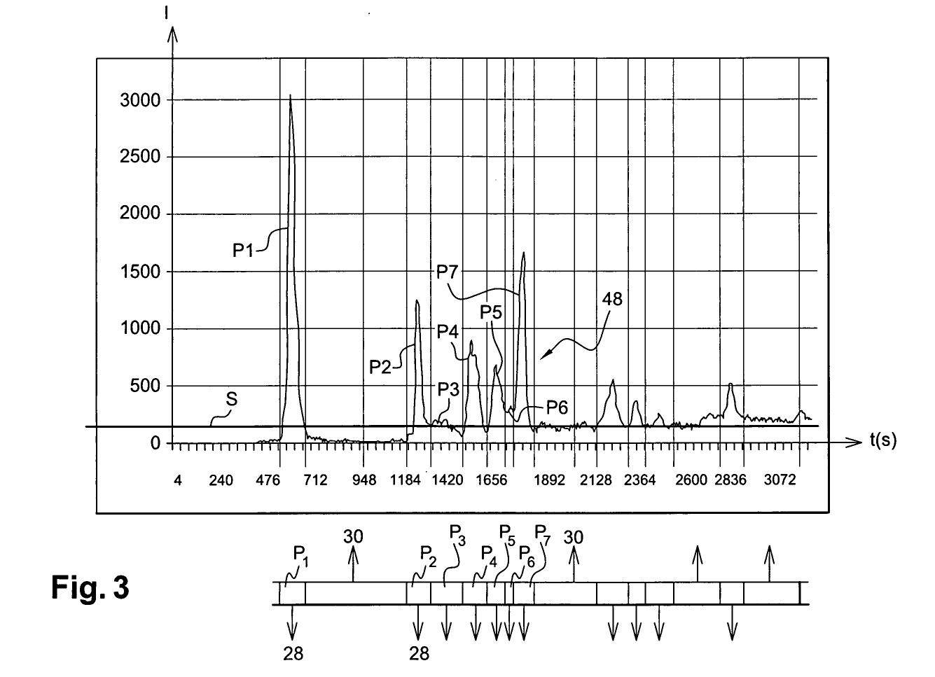

It is thus possible to take a new series of samples once very 6 seconds in this particular example. The analysis performed by the measurement apparatus 14 is almost instantaneous, thereby making it possible to determine once every 6 seconds the values of a characteristic magnitude, such as molecular weight, for the components passing at that time along the various separation channels through the sample-taking means 10. The information about the characteristic magnitudes supplied by the measurement apparatus 14 is transmitted to a data processor system 46 which also receives the signals supplied by the measurement cells 16, with an example thereof being shown diagrammatically in FIG. 3.

Curve 48 in FIG. 3 shows how the absorption of ultraviolet light by the components passing along one of the separation channels in the installation of the invention varies as a function of time, with the intensity of absorption being plotted up the ordinate in arbitrary units and with time being plotted along the abscissa in seconds.

It can be seen that the curve 48 presents a first peak P1 corresponding to a first component passing through the measurement cell 16, with this passage beginning at an instant t=476 seconds and ending at an instant t=712 seconds, and with the intensity of the peak corresponding to the concentration of the component.

A second peak P2 corresponds to a second component passing through the measurement cell 16 starting at t=1184 seconds, this second component being followed by other components corresponding to peaks P3, P4, P5, P6, and P7 of the curve up to an instant t=1892 seconds.

The peaks are preferably defined relative to a threshold S, above which the signal is considered as corresponding to a component passing along the separation channel. The portions of the curve 48 that lie above the threshold S correspond to components that are to be selected and deposited in the collector means 28, while the portions of the curve that lie beneath the threshold S correspond to fractions leaving the separation channel that are to be directed to the disposal or exhaust duct 30.

In the diagram of the separation channel located beneath the curve 48 in FIG. 3, arrows pointing downwards represent components leaving the separation channel that are to be deposited in the collector means 28, while arrows pointing upwards represent the fraction that are to be directed towards the disposal duct 30.

The information received from the measurement apparatus 14 and the measurement cells 16 by the data processor system 46 serves to control the selective connection means 22 and 24 synchronously with the passage of the components and fractions at the outlet of the various separation channels so as to ensure that these components and fractions are stored temporarily in the means 20.

In greater detail, operation is as follows:

The lengths of the separation channels between the measurement cells 16 and the inlets of the temporary storage means 20 are sufficient for the information supplied by the measurement apparatus 14 and the measurement cells 16 concerning the passage of components to be processed by the system 46 and for certain necessary operations to be performed prior to the components reaching the outlets of the separation channels.

It is assumed that in the separation channels A, B, and C shown in FIG. 4a, the separated components or fractions follow one another in the order shown, i.e. that the peaks P1, P2, and P3 corresponding to the components that are to be collected follow one another at the outlet from channel A, and are followed by a fraction F1 that is to be disposed of, then by a new peak P4, corresponding to a component that is to be collected, etc.

At the outlet from separation channel B, there can be seen a first peak P′1 corresponding to a component that is to be collected, then a fraction F′1 that is to be disposed of, followed by another peak P′2 corresponding to a component that is to be collected, etc. . . . .

At the outlet from the separation channel C, there follow a succession a first peak P′1 corresponding to a component to be collected, a fraction F″1 to be disposed of, a peak P″2 corresponding to another component that is to be collected, etc.

The beginning of the first peak P1 is detected by the measurement cell 16 in the separation channel A and the corresponding signal is transmitted to the data processor system 46 which, at the moment when said beginning of the first peak reaches the selective connection means 22, causes said means to connect the outlet 18 of the separation channel A to the inlet of a first of two temporary storage means 20.

The end of the first peak P1 is detected by the measurement cell 16 and is transmitted to the data processor system 46 which, at the appropriate moment, closes the connection between the outlet 18 of the separation channel A and the inlet to the temporary storage means 20, and connects the outlet 18 of the channel A to the inlet of the second temporary storage means 20.

While the component corresponding to the second peak P2 is being stored in the second means 20, transport fluid under pressure is admitted into the first temporary storage means 20 from the source 36 under the control of the selective connection means 22, and the outlet from the first temporary storage means 20 is connected under the control of the system 46 to the duct 26 corresponding to deposition in a collector means 28.

The collector means 28 can be constituted by any suitable receiver means, e.g. by a plate 50 having micro-wells (e.g. 96 micro-wells each having a volume of 2.5 mL), or by a strip of reaction wells, or by a series of test tubes, etc.

When the collector means are formed by a plate 50 having a relatively large number of micro-wells arranged in rows and columns, one row of micro-wells will be associated with the separation channel A, the next row of micro-wells will be associated with the separation channel B, and so on, and the first component leaving the duct 26 associated with the separation channel A will be deposited in the first micro-well of the corresponding row, the second component leaving the deposition duct 26 will be deposited in the second micro-well of the same row, and so on, the positions of the micro-wells possibly being designated by references to the separation channels associated with the rows of micro-wells, and by numbers for the micro-well columns in the plate. Thus, the first component collected at the outlet from separation channel A will be deposited in micro-well A1, the second component collected at the outlet from this channel will be deposited in micro-well A2, and so on.

For each deposition of a component in a corresponding collector means 28, the moving arm 32 carrying the deposition duct 26 is moved in translation by the motor-driven means 34 in a direction that is parallel to the directions of the rows of micro-wells associated with the separation channels.

To deposit the component corresponding to the peak P1 in the micro-well A1, the moving arm 32 is brought into position 1 over the plate 50 of micro-wells. To deposit the component corresponding to the peak P2 in the micro-well A2, the moving arm is brought into position 2 over the plate, and so on.

Similarly, to deposit the component corresponding to the peak P′1 from the separation channel B, the moving arm 32 is brought into position 1 and deposits the component in micro-well B1, and then at the appropriate moment, it is brought into position 2 in order to deposit the component corresponding to peak P′2 in micro-well B2, and so on.

When the succession of components in the various separation channels is as shown diagrammatically in FIG. 4a, the sequence of movements of the moving arm 32 will be as follows, as shown diagrammatically in FIG. 4b:

The component corresponding to peak P1 in separation channel A is the first to be stored temporarily and is therefore the first to be deposited in the corresponding collector means 28 (micro-well A1 in the plate). Thereafter it is the component corresponding to the peak P′1 that has been stored temporarily in one of the means 20 associated with the separation channel B that is deposited in micro-well B1. Then, it is the component corresponding to peak P2 from separation channel A that is stored temporarily and then deposited in micro-well A2. Theater, it is the component corresponding to peak P″1 from the separation channel C that is stored temporarily and deposited in micro-well C1, and then the component corresponding to peak P3 from separation channel A is stored temporarily and deposited in micro-well A3, then the component corresponding to peak P′2 from separation channel B is stored temporarily and deposited in micro-well B2, after which the component corresponding to peak P4 from separation channel A is stored temporarily and deposited in micro-well A4, etc.

The moving arm 32 is brought into position 1 to make deposits into micro-wells A1 and B1, then into position 2 to deposit in micro-well A2, it is returned to position 1 to deposit in micro-well C1, moved to position 3 to deposit in micro-well A3, returned to position 2 to deposit in micro-well B2, taken to position 4 to deposit in micro-well A4, etc.

The volume corresponding to a peak in a separation channel is of milliliter order. Since the outlet flow rate from a separation channel is of the order of 250 μL per minute, one or more minutes are needed to store a component in a temporary storage means 20 of volume that lies typically in the range 1 mL or 2 mL to 5 mL.

Extracting the component stored in a temporary storage means by admitting a transport fluid under pressure into the temporary storage means 20 takes a few seconds. Thus, after a component has been deposited in a micro-well of a plate, there is plenty of time to prepare for depositing the following component in another micro-well. This makes it possible in particular to wash the deposition duct 26 in the moving arm 32 between successive depositions. By way of example, and as mentioned above, this washing is performed by selective connection means connecting a source 38 of washing fluid under pressure to the deposition duct 26 that is to be washed.

Advantageously, when the selective connection means 24 connect a temporary storage means 20 to a common disposal duct 30, advantage is taken of that situation to connect the corresponding deposition duct 26 to the source 38 of washing fluid, the moving arm 32 being returned for this purpose into a position 0 where the deposition ducts 26 do not overlie the collector means 28, thus enabling the washing fluid that leaves the ducts 26, to be recovered in a suitable receptacle.

1. An installation for separating components, in particular by high-pressure liquid chromatography, the installation comprising a plurality of parallel separation channels (A, B, C, D, . . . ), means for detecting the passage of components along the separation channels, and collector means for collecting at least some of the components leaving the separation channels, the installation comprising, between the outlet from each separation channel and the collector means, at least two parallel temporary storage means, first controlled selective connection means for selectively connecting the outlet of said separation channel to the inlet of one or the other of the temporary storage means, second controlled selective connection means for connecting the outlets of the temporary storage means to the collector means or to disposal means, and control means generating control signals for controlling said selective connection means on the basis of signals output by the detector means.

2. An installation according to claim 1, also comprising a moving arm carrying the outlets from the temporary storage means, control means for controlling displacement of said arm in translation over collector means formed, for example, by plates of micro-wells, series of tubes, strips of reaction wells, or the like, and third controlled selective connection means for connecting the inlets of the temporary storage means to feed means for supplying gas or liquid under pressure to transport the components contained in the temporary storage means to the collector means or to the disposal means.

3. An installation according to claim 2, wherein, for each separator channel, the temporary storage means comprise at least two ducts having inlets connected in parallel via the first controlled selective connection means to the outlet of the separator channel and having outlets connected via the second controlled selective connection means either to ducts carried by the above-mentioned moving arm and leading to the collector means, or else to the disposal means.

4. An installation according to claim 1, wherein the first and second controlled selective connection means comprise electrically-controlled valves and/or check valves.

5. An installation according to claim 1, wherein the detector means comprise cells for detecting the passage of separated components in each channel, said detector cells being, for example, of the type operating by measuring absorption of light radiation.

6. An installation according to claim 1, further comprising measurement apparatus for measuring a magnitude that is characteristic of the components passing along said separation channels, such as, for example, their molecular weight, and means for feeding said apparatus with a train of component samples taken from said separation channels.

7. An installation according to claim 6, including control means for taking a predetermined or programmable quantity of components from each separation channel, means for depositing the taken quantities into a duct connecting the sample-taking means in series to the measurement apparatus, and transport means for transporting the taken quantities of components along said duct to the measurement apparatus.

8. An installation according to claim 7, wherein the transport means include a flow-driving pump connected to the end of the duct remote from the measurement apparatus.

9. An installation according to claim 7, wherein the sample-taking means comprise electrically-controlled valves.

10. An installation according to claim 7, wherein a respective sample-taking means is connected to each separation channel and comprises moving portion formed with or connected to a chamber for receiving a predetermined small volume of component, and means for selectively displacing said moving portion to insert said chamber in the separation channel or in the duct leading to the measurement apparatus.

11. An installation according to claim 6, wherein the measurement apparatus is a mass spectrometer or an evaporative detector using light diffusion.

12. An installation according to claim 7, wherein the sample-taking means are operated simultaneously.

13. An installation according to claim 1, including a data processor system which receives as input the output signals from the measurement apparatus representing a magnitude that is characteristic of each component passing along the separation channels, and output signals from the means for detecting the passage of said components along the separation channels, and serving to generate signals for controlling the selective connection means connecting the outlets of the separation channels to the inlets of the temporary storage means and the outlets of the temporary storage means to the collector means or to the disposal means.

14. An installation according to claim 13, wherein the data processor system also generates control signals for the selective connection means connecting a source of washing fluid to the outlets of the temporary storage means that are connected to the disposal means.
